(19) United States
(12) Patent Application Publication
(10) Pub. No.: US 2006/0001399 A1
(43) Pub. Date: Jan. 5, 2006

(54) High temperature battery system for hybrid locomotive and offhighway vehicles

(76) Inventors: Lembit Salasoo, Schenectady, NY (US); Robert Dean King, Schenectady, NY (US); Ajith Kuttannair Kumar, Erie, PA (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/884,501

(22) Filed: Jul. 2, 2004

(51) Int. Cl. H02J 7/14

(52) U.S. Cl. 320/104

(57) ABSTRACT

An electric storage battery system carried on a hybrid energy off-highway vehicle including wheels for supporting and moving the vehicle, an electrical power generator, and traction motors for driving the wheels, with electrical power generated on the vehicle being stored at selected times in the electric storage battery system and discharged from the electric storage battery system for transmission to the traction motors to propel the vehicle, with the vehicle and battery system being exposed to a range of environmental conditions is provided. The storage battery system includes at least one battery for storing and releasing electrical power, wherein the at least one battery generates an internal battery operating temperature that is independent of and exceeds the highest environmental temperature of the vehicle and the at least one battery.

### GOVERNMENT INTERESTS

This disclosure was made with Government support under Contract No. DE-FC04-2002AL68284 awarded by the Department of Energy. The Government has certain rights in this disclosure.

### BACKGROUND OF THE DISCLOSURE

This disclosure relates generally to control systems and methods for use in connection with large, off-highway vehicles such as locomotives, large excavators, dump trucks etc. In particular, the disclosure relates to a system and method for controlling a temperature of a battery used for storage and transfer of electrical energy, such as dynamic braking energy or excess prime mover power, produced by diesel-electric locomotives and other large, off-highway vehicles driven by electric traction motors.

FIG. 1 is a block diagram of an exemplary prior art locomotive 100. In particular, FIG. 1 generally reflects a typical prior art diesel-electric locomotive such as, for example, the AC6000 or the AC4400, both or which are available from General Electric Transportation Systems. As illustrated in FIG. 1, the locomotive 100 includes a diesel engine 102 driving an alternator/rectifier 104. As is generally understood in the art, the alternator/rectifier 104 provides DC electric power to an inverter 106 which converts the DC electric power to AC to form suitable for use by a traction motor 108 mounted on a truck below the main engine housing. One common locomotive configuration includes one inverter/traction motor pair per axle. FIG. 1 illustrates two inverters 106 for illustrative purposes.

Strictly speaking, an inverter converts DC power to AC power. A rectifier converts AC power to DC power. The term converter is also sometimes used to refer to inverters and rectifiers. The electrical power supplied in this manner may be referred to as prime mover power (or primary electric power) and the alternator/rectifier 104 may be referred to as a source of prime mover power. In a typical AC diesel-electric locomotive application, the AC electric power from the alternator is first rectified (converted to DC). The rectified AC is thereafter inverted (e.g., using power electronics such as Insulated Gate Bipolar Transistors (IGBTs) or thyristors operating as pulse width modulators) to provide a suitable form of AC power for the respective traction motor 108.

As is understood in the art, traction motors 108 provide the tractive power to move locomotive 100 and any other vehicles, such as load vehicles, attached to locomotive 100. Such traction motors 108 may be AC or DC electric motors. When using DC traction motors, the output of the alternator is typically rectified to provide appropriate DC power. When using AC traction motors, the alternator output is typically rectified to DC and thereafter inverted to three-phase AC before being supplied to traction motors 108.

The traction motors 108 also provide a braking force for controlling speed or for slowing locomotive 100. This is commonly referred to as, dynamic braking, and is generally understood in the art. Simply stated, when a traction motor is not needed to provide motivating force, it can be reconfigured (via power switching devices) so that the motor operates as a generator. So configured, the traction motor generates electric energy which has the effect of slowing the locomotive. In prior art locomotives, such as the locomotive illustrated in FIG. 1, the energy generated in the dynamic braking mode is typically transferred to resistance grids 110 mounted on the locomotive housing. Thus, the dynamic braking energy is converted to heat and dissipated from the system. In other words, electric energy generated in the dynamic braking mode is typically wasted.

It should be noted that, in a typical prior art DC locomotive, the dynamic braking grids are connected to the traction motors. In a typical prior art AC locomotive, however, the dynamic braking grids are connected to the DC traction bus 112 because each traction motor is normally connected to the bus by way of an associated inverter (see FIG. 1).

To avoid wasting the generated energy, hybrid energy locomotive systems were developed to include energy capture and storage systems 114 for capturing and regenerating at least a portion of the dynamic braking electric energy generated when the locomotive traction motors operate in a dynamic braking mode. The energy capture and storage system 114 not only captures and stores electric energy generated in the dynamic braking mode of the locomotive, it also supplies the stored energy to assist the locomotive effort (i.e., to supplement and/or replace prime mover power). The energy capture and storage system 114 preferably includes at least one of the following storage subsystems 116 for storing the electrical energy generated during the dynamic braking mode: a battery subsystem, a flywheel subsystem, or an ultra-capacitor subsystem and a converter 118. Other storage subsystems are possible. This energy storage and reutilization improves the performance characteristics (fuel efficiency, horse power, emissions etc) of the locomotive. Exemplary hybrid locomotive and off-highway vehicles and systems are described in U.S. Pat. Nos. 6,591,758, 6,612,245, 6,612,246 and 6, 615, 118 and U.S. patent application Ser. Nos. 10/378,335, 10/378,431 and 10/435,261, all of which are assigned to the assignee of the present disclosure, the contents of which are hereby incorporated by reference.

These vehicles have to operate over a wide range of environmental conditions including temperature variations. The typical range of ambient temperature is −40 C to +50 C with some applications extending to −50 C and +60 C. One of the energy storage devices 116 employed in such vehicles is batteries of various types e.g., Lead-Acid, Nickel Cadmium, Lithium ion, Nickel Metal Hydride, etc. The battery performance depends heavily on its internal temperature. For example, the Nickel Cadmium battery needs to be derated if the battery temperature is above 40 C or if it is below 0 C, and needs significant (may be almost inoperable in some cases) derating below −20 C and above 55 C. Since a significant portion of the locomotive operation is in this range, the battery size needs to be increased significantly or usage limited drastically during this temperature operation. Moreover, the life of the battery also gets effected adversely.

Similarly, other types of batteries have different temperature operating capability. These batteries are typically cooled by forced air and some times by liquid cooling (e.g., hydronic systems) and the liquid itself is later cooled by air. Since the ambient air temperature range is wide to operate the batteries at their optimal performance, either the cooling air need to conditioned or performance adjusted, e.g., deration of the batteries. During low temperature operation, air needs to be heated before cooling the battery to prevent battery temperature from falling too low or requiring deration. Additionally for cooling airflow to provide cooling action directly or via an intermediate hydronic coolant loop to the hybrid energy storage battery, the temperature of the airflow must be below the battery temperature. Since the range of ambient air temperatures that locomotives and other off-highway vehicles must operate may be as high as 60 C, high-ambient temperature hybrid vehicle operation presents a challenge for most energy storage technologies. Either the cooling air needs to be precooled or the battery performance derated. These cooling/heating operations and systems are complex and add weight/size/cost penalties.

Therefore, there is a need for a high temperature battery and system for locomotives and off-highway vehicle for operating in a wide range of temperatures which require no precooling of cooling air and said system being capable of controlling a temperature of the battery to ensure optimal performance.

### BRIEF DESCRIPTION OF THE DISCLOSURE

An electric storage battery system carried on a hybrid energy off-highway vehicle including wheels for supporting and moving the vehicle, an electrical power generator, and traction motors for driving the wheels, with electrical power generated on the vehicle being stored at selected times in the electric storage battery system and discharged from the electric storage battery system for transmission to the traction motors to propel the vehicle, with the vehicle and battery system being exposed to a range of environmental conditions is provided. The storage battery system includes at least one battery for storing and releasing electrical power, wherein the at least one battery generates an internal battery operating temperature that exceeds the highest environmental temperature of the vehicle.

In another aspect of the present disclosure, an electric storage battery system carried on a hybrid energy off-highway vehicle including wheels for supporting and moving the vehicle, an electrical power generator, and traction motors for driving the wheels, with electrical power generated on the vehicle being stored at selected times in the electric storage battery system and discharged from the electric storage battery system for transmission to the traction motors to propel the vehicle, with the vehicle and battery system being exposed to a range of environmental conditions is provided, the electric storage battery system including at least one battery to store and release electrical power, with the battery operating at an internal battery temperature for effective storage and release of electric power, constituting an effective battery temperature, that is above that of the environmental temperatures of the vehicle and battery system, and with the battery cooling to a temperature lower than its effective internal operating temperature when the vehicle is out of service for extended period of time; a monitor for sensing a parameter indicative of internal battery temperature; and a controller for controlling heating of the battery back up to its effective battery temperature when the internal battery temperature falls below a predetermined level, so that the battery remains ready to operate effectively when the vehicle is returned to operation.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram of a conventional hybrid locomotive propulsion system;

FIG. 2 is a block diagram of an embodiment of a hybrid energy propulsion system of the present disclosure;

FIG. 3 is a block diagram of a battery control system;

FIG. 4A is a block diagram of a conventional hydronic engine cooling system;

FIGS. 4B-4D are block diagrams of hydronic cooling systems according to the principles of the present disclosure;

FIG. 5A is a block diagram of a conventional air cooling system; and

FIGS. 5B-5I are block diagrams of air cooling systems according to the principles of the present disclosure.

### DETAILED DESCRIPTION OF THE DISCLOSURE

Preferred embodiments of the present disclosure will be described hereinbelow with reference to the accompanying drawings. In the following description, well-known functions or constructions are not described in detail to avoid obscuring the disclosure in unnecessary detail.

A battery, battery control system and method for use in locomotives and large off-highway vehicles are provided. The system and method of the present disclosure utilizes batteries that operate at high internal temperatures, for example, a Sodium Nickel Chloride battery which operates at temperatures above 270° C. or, as another example, a Sodium Sulfur battery that can operate at temperatures above 350° C. These batteries utilize a chemical reaction, e.g., an exothermic reaction, for storing and releasing electrical energy or power. The exothermic reaction generates an internal operating temperature that is independent of and exceeds the highest environmental temperature of the vehicle. By utilizing a high temperature battery in a hybrid off-highway vehicle, no pre-cooling is required of the cooling air needed for the hybrid energy storage battery (under even the hottest ambient air temperature conditions). The conventional battery technologies either have to be derated under the hottest ambient air temperature conditions, or require some precooling of the air used for heat rejection, under the hottest ambient air temperature conditions. Conventional batteries, are capable of operation for short time periods at temperatures of 50° C., but need to be operated at less than about 35° C. to meet manufacturer's life projections.

Even though these high temperature batteries need to be heated initially, as long as they are operating, the batteries will maintain the high temperature. Once these batteries are operating, they will need cooling. Any battery which operates above the operating ambient temperature of the locomotive can be effectively cooled with available ambient cooling air either directly or through a liquid or heat sink interface, and therefore, the ambient air requires no precooling. Advantageously, no cooling of air or a liquid (e.g., a coolant) is required and, at the same time, no deration of the battery is required during a high operating temperature range.

The cooling medium and the cooling circuit/system which is used in conjunction with the battery control system of the present disclosure is integrated in to the vehicle systems. Since the cooling of the battery is only required (typically) when the vehicle is producing power (ex motoring, braking) and since other traction and control functions are also working during that period, the cooling requirements of the traction/auxiliary system can be integrated. For example, cooling air can be drawn from the traction motor cooling blower. Since the battery runs at high temperatures (250-350C), the battery can be cooled by the preheated air (i.e., air which has cooled other components like power electronics, traction alternator, traction motors, radiator, auxiliary equipment etc) and hence the cooling system can be simplified. It is also possible to integrate the battery cooling with the engine radiator water system by using the water as the cooling medium. Various possible air/water cooling systems will be described below.

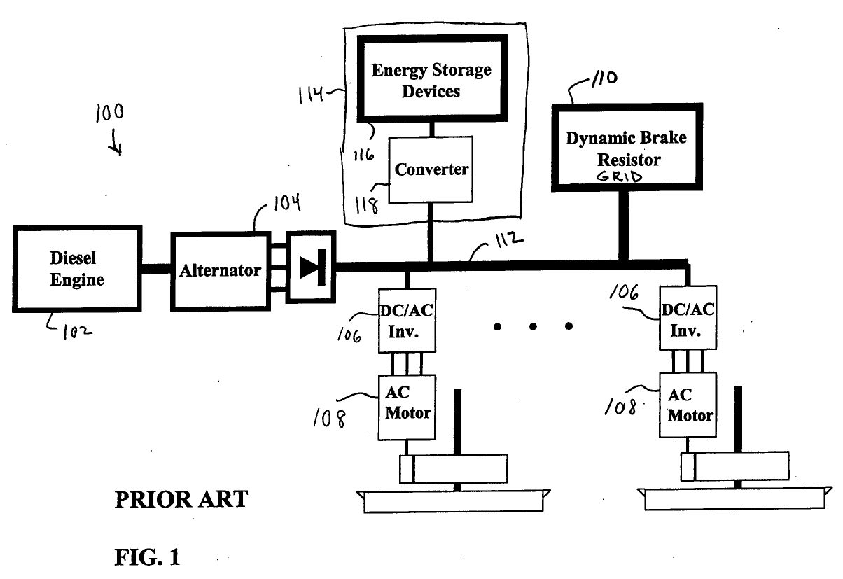

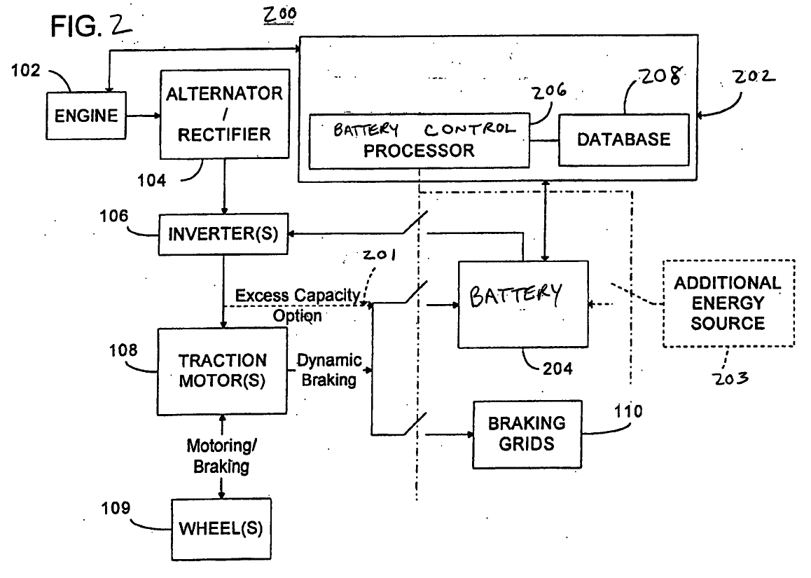

FIG. 2 is a system-level block diagram that illustrates aspects of a battery control system 200 of the present disclosure. In particular, FIG. 2 illustrates a battery control system 200 suitable for use with a hybrid energy locomotive system, such as hybrid energy locomotive system 100 shown in FIG. 1. It should be understood, however, that the battery control system 200 illustrated in FIG. 2 is also suitable for use with other large, off-highway vehicles. Such vehicles include, for example, large excavators, excavation dump trucks, and the like. By way of further example, such large excavation dump trucks may employ motorized wheels such as the GEB23.TM. AC motorized wheel employing the GE150AC.TM. drive system (both of which are available from the assignee of the present invention). Therefore, although FIG. 2 is generally described with respect to a locomotive system, the battery control system 200 illustrated therein is not to be considered as limited to locomotive applications.

As illustrated in FIG. 2, a diesel engine 102 drives a prime mover power source 104 (e.g., an alternator/rectifier converter). The prime mover power source 104 preferably supplies DC power to an inverter 106 that provides three-phase AC power to a locomotive traction motor 108. It should be understood, however, that the system 200 illustrated in FIG. 2 can be modified to operate with DC traction motors as well. Preferably, there is a plurality of traction motors (e.g., one per axle), and each axle is coupled to a plurality of locomotive wheels 109. In other words, each locomotive traction motor preferably includes a rotatable shaft coupled to the associated axle for providing tractive power to the wheels. Thus, each locomotive traction motor 108 provides the necessary motoring force to an associated plurality of locomotive wheels 109 to cause the locomotive to move.

When traction motors 108 are operated in a dynamic braking mode, at least a portion of the generated electrical power is routed to an energy storage medium such as battery 204. To the extent that battery 204 is unable to receive and/or store all of the dynamic braking energy, the excess energy is preferably routed to braking grids 110 for dissipation as heat energy. Also, during periods when engine 102 is being operated such that it provides more energy than needed to drive traction motors 108, the excess capacity (also referred to as excess prime mover electric power) may be optionally stored in battery 204. Accordingly, battery 204 can be charged at times other than when traction motors 108 are operating in the dynamic braking mode. This aspect of the system is illustrated in FIG. 2 by a dashed line 201, where the inverter 106 is controlled as a DC/DC converter (not illustrated in FIG. 2).

The battery 204 of FIG. 2 is preferably constructed and arranged to selectively augment the power provided to traction motors 108 or, optionally, to power separate traction motors associated with a separate energy tender vehicle or a load vehicle. Such power may be referred to as secondary electric power and is derived from the electrical energy stored in battery 204. Thus, the system 200 illustrated in FIG. 2 is suitable for use in connection with a locomotive having an on-board energy storage medium and/or with a separate energy tender vehicle.

The system 200 includes a battery control system 202 for controlling various operations associated with the battery 204, such as controlling a temperature of the battery and/or charging/discharging of the battery. FIG. 2 also illustrates an optional energy source 203 that is preferably controlled by the battery control system 202. The optional energy source 203 may be a second engine (e.g., the charging engine or another locomotive) or a completely separate power source (e.g., a wayside power source such as a battery charger) for charging battery 204. In one preferred embodiment, optional energy source 203 is connected to a traction bus (not illustrated in FIG. 2) that also carries primary electric power from prime mover power source 104.

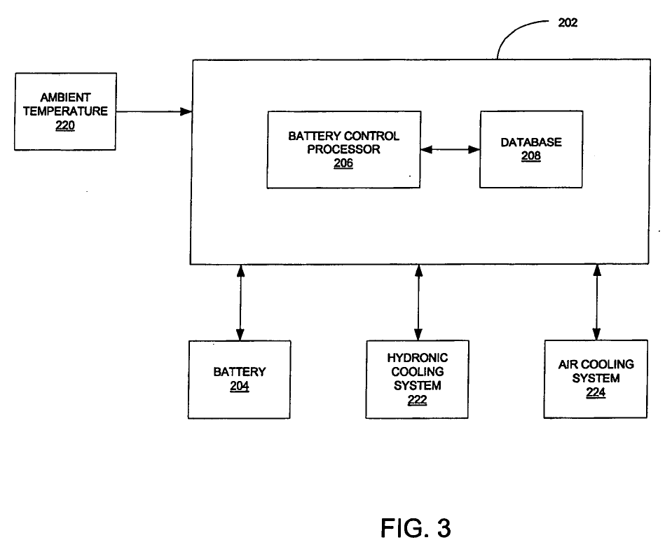

As illustrated in FIG. 3, the battery control system 202 preferably includes a battery control processor 206 and a database 208. The battery control processor 206 determines various environmental conditions, e.g., ambient temperature of the battery, and uses this environmental information to locate data in the database 208 to estimate an internal temperature of the battery. It is to be understood that such database information could be provided by a variety of sources including: an onboard database associated with processor 206, a communication system (e.g., a wireless communication system) providing the information from a central source, manual operator input(s), via one or more wayside signaling devices, a combination of such sources, and the like. Finally, other vehicle information such as, the size and weight of the vehicle, a power capacity associated with the prime mover, efficiency ratings, present and anticipated speed, present and anticipated electrical load, and so on may also be included in a database (or supplied in real or near real time) and used by battery control processor 206.

The battery internal temperature is used for various control decisions including charging and discharge limits and for deciding whether to start the engine back to reheat or to allow it to freeze, etc. Generally, the internal battery temperature is difficult to measure due to sensor cost and complexity. Therefore, the battery control processor 206 of the present disclosure estimates the internal battery temperature using thermal models stored in the database 208. The thermal models are based on various inputs including potential battery case temperature, ambient temperature/pressure, time history of battery charge/discharge current, and time history of battery cooling fan(s) operation (coolant temperature/flow). These inputs are used to estimate internal temperature of battery cells within a battery module. Projected internal battery temperature from all of the battery modules can be used to compare to actual temperature measurements within at least one selected module for comparison with the thermal model. If projected temperature departs by XX degrees C. from the measured temperature appropriate action (like deration, operator annunciation, schedule maintenance etc) can be taken. If the projected temperature departs by YY degrees C. from the measured temperature(s), (where YY>XX, (for example, the value of XX could be approximately 5 degrees C., while the value of YY could be approximately 10 degrees C.), further restrictive steps can be taken. This could include disabling of the battery operation. The battery thermal model uses externally sensed values of battery current, battery voltage, plus SOC that is computed from the net integrated Ampere hour. In addition, the history and trend of recent battery use during battery charge and discharge in the vehicle is used as part of the model to project the present battery temperature. Furthermore, resistance across the terminals of the battery may be used to determine the temperature model and/or resistance at a specific SOC. Characteristics, based on cell tests in the laboratory at various temperatures are used to develop the initial model. Results from initial thermal models are compared to actual sensed battery temperature for representative charge and discharge cycles. Model refinement is made based on the laboratory test results.

Once the thermal model for the battery is determined, the battery processor 206 will acquire various system parameters, e.g., from the hydronic cooling system 222 and air cooling system 224, and control various devices in these systems to control the temperature of the battery 204. The cooling media may be controlled such a way that on systems with multiple parallel battery units, the temperature of each component is controlled within a predetermined limit. Parallel operation of individual battery units is generally required to obtain the battery discharge and recharge powers sufficient for locomotive and Off-Highway Vehicle applications. This could be achieved by various techniques including independent temperature/cooling system regulators, as will be described below.

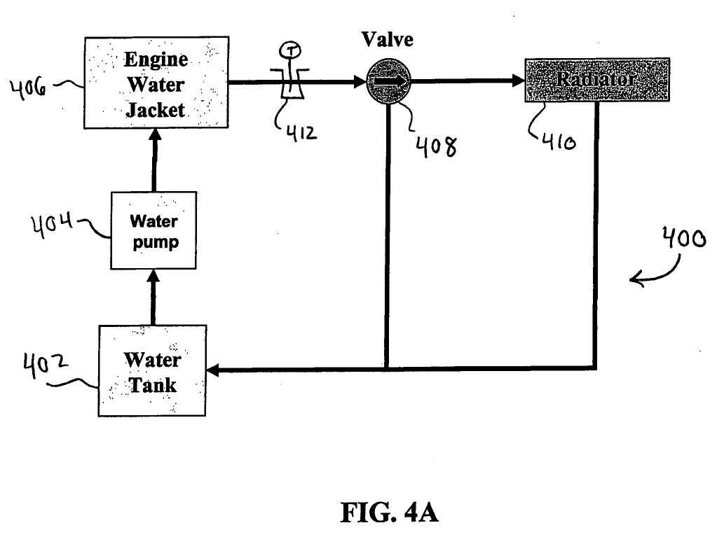

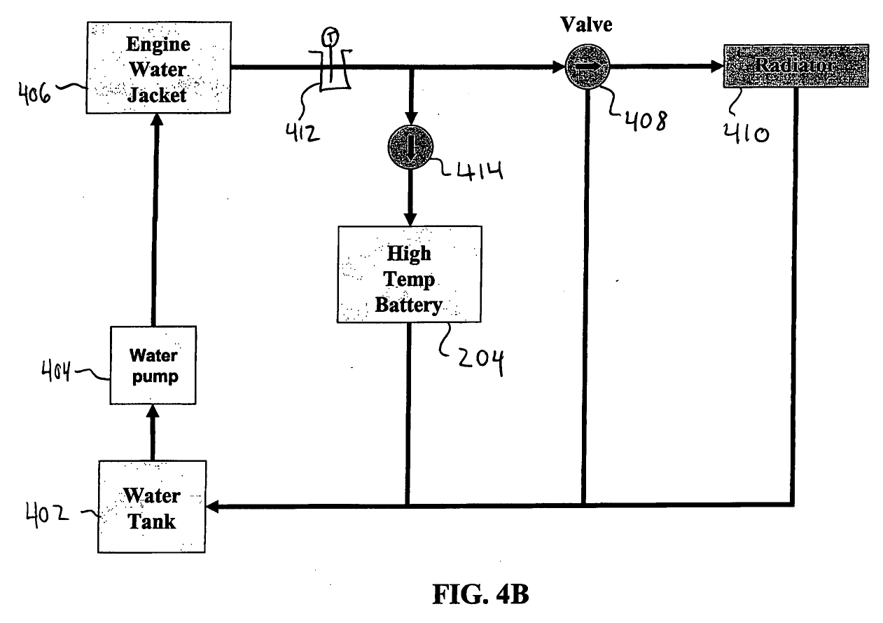

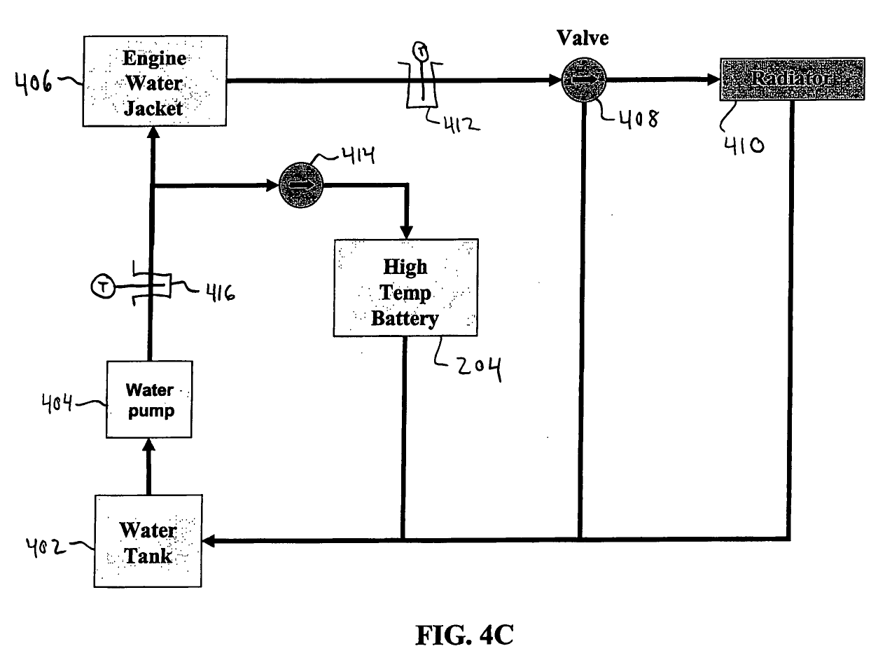

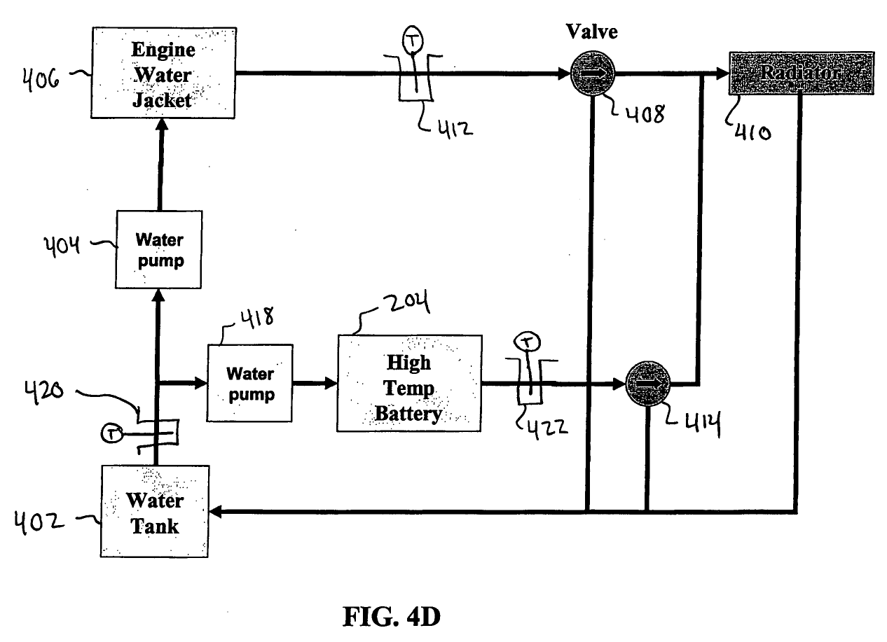

Referring to FIG. 4A, a conventional hydronic engine cooling system 400 is illustrated. Such a system generally includes a water tank 402 for holding water or other cooling medium, e.g., a coolant, a water pump 404 for pumping the coolant through the system, and a engine water jacket 406 which cools the engine by circulating coolant around the engine. A temperature sensor 412 located in the discharge line of the water jacket will determine whether the coolant is above a predetermined temperature, and if so, will position valve 408 to circulate the coolant through radiator 410. Otherwise, the coolant will be allowed to flow directly back to the water tank 402.

FIGS. 4B through 4D illustrate hydronic cooling systems according to the principles of the present disclosure. In the hydronic cooling systems, the high temperature battery 204 may include a water jacket for cooling or lower the temperature of the battery. In FIG. 4B, once the battery processor 206 has determined the internal temperature of the battery, the processor 206 will acquire the temperature of the coolant at sensor 412. If the battery 204 requires cooling, the processor will sent first and second control signals to valves 408, 414 respectively, to divert a portion of the flow of coolant to the battery. It is to be appreciated that valves 408 and 412 may be a single 3-way valve. When the battery 204 has reached a satisfactory temperature, the processor 206 will control valves 408, 414 to have full flow of coolant to the radiator 410.

FIG. 4C is another embodiment of a hydronic cooling system used in conjunction with the battery control system of the present disclosure. In FIG. 4C, coolant is diverted by valve 414 to the battery 204 before cooling the engine via the engine water jacket 406. Here, the coolant contacting the battery will be of a lower temperature than that shown in FIG. 4B and will be able to provide a greater amount of cooling. Additionally, the hydronic system of FIG. 4C will include temperature sensor 416 for use by the processor 206 to determine if the coolant is available to cool the battery.

FIG. 4D shows another embodiment of a hydronic cooling system used in conjunction with the battery control system of the present invention. Second water pump 418 is configured to provide extra capacity to the battery 204. Temperature sensor 420 will transmit a temperature signal to the processor 206 to allow the processor to determine if coolant is available for cooling. Temperature sensor 422 will sense the temperature of the coolant after it discharges from the battery 204 and the processor will use this temperature to determine if the discharge coolant needs to be cooled via the radiator 410 or can be sent back to the water tank 402. Based on this determination, the processor 206 will control valve 414 to the appropriate position.

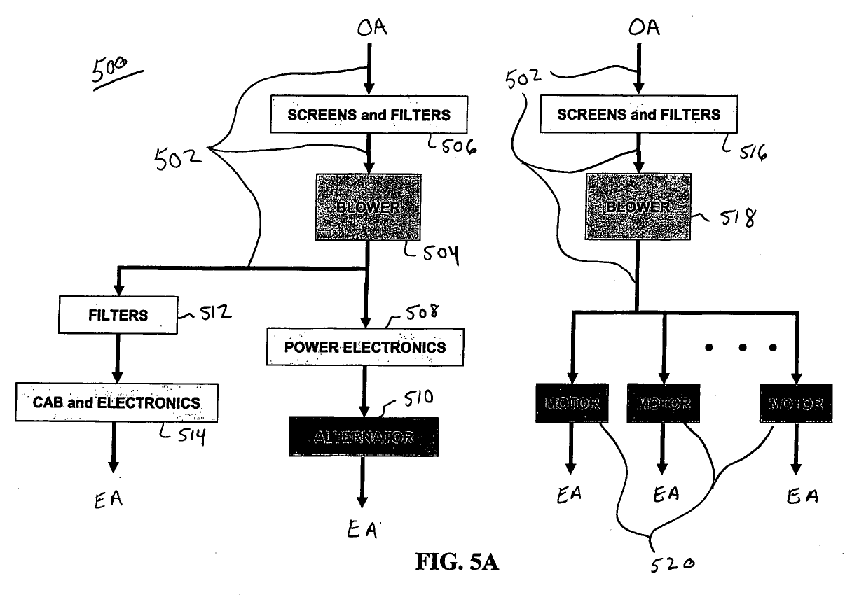

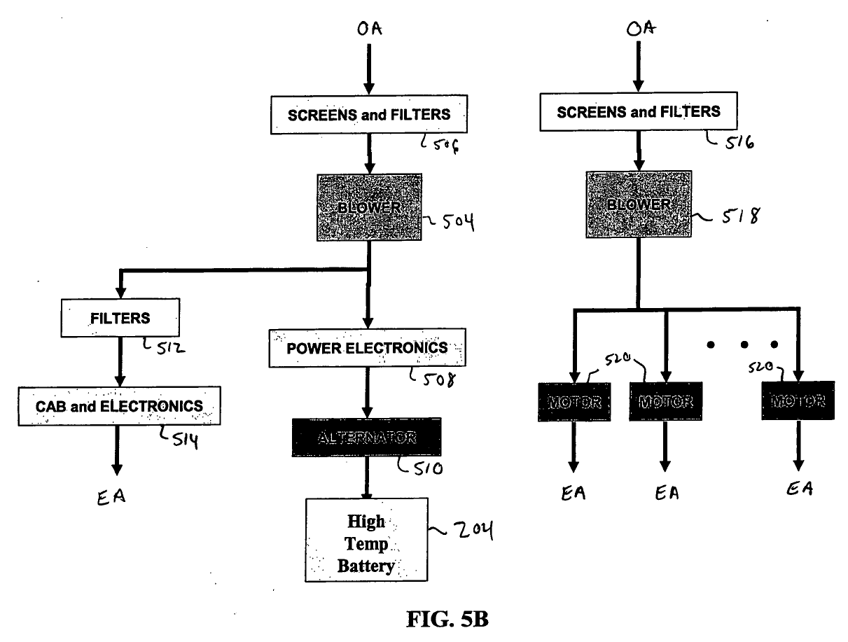

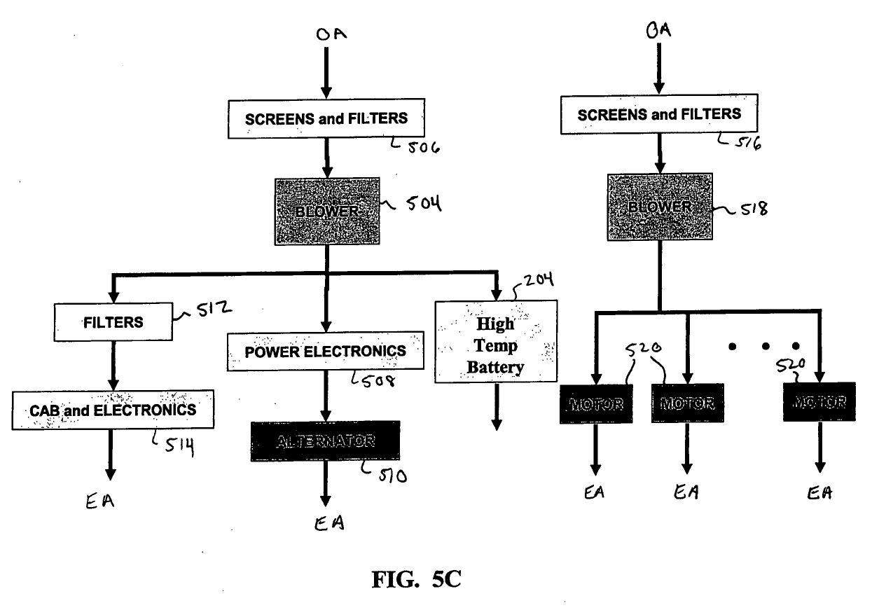

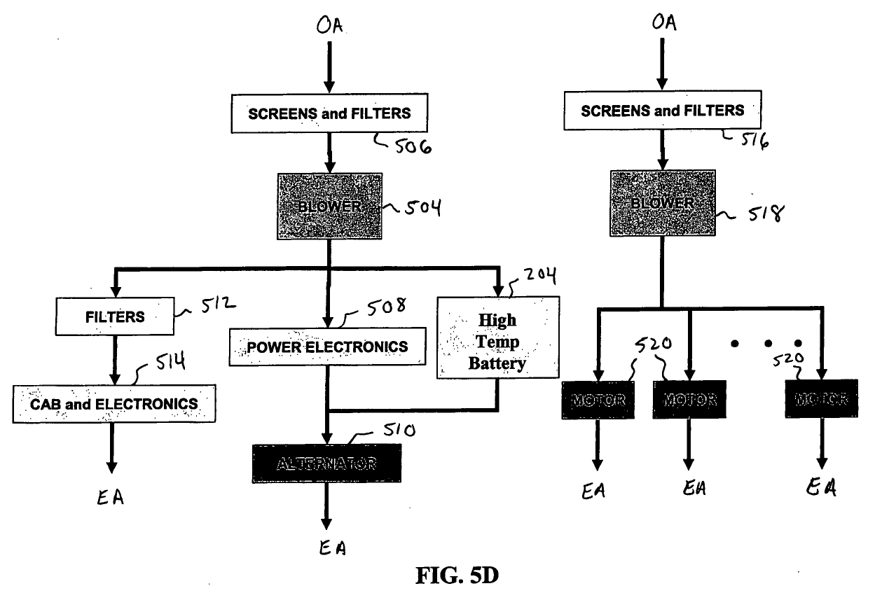

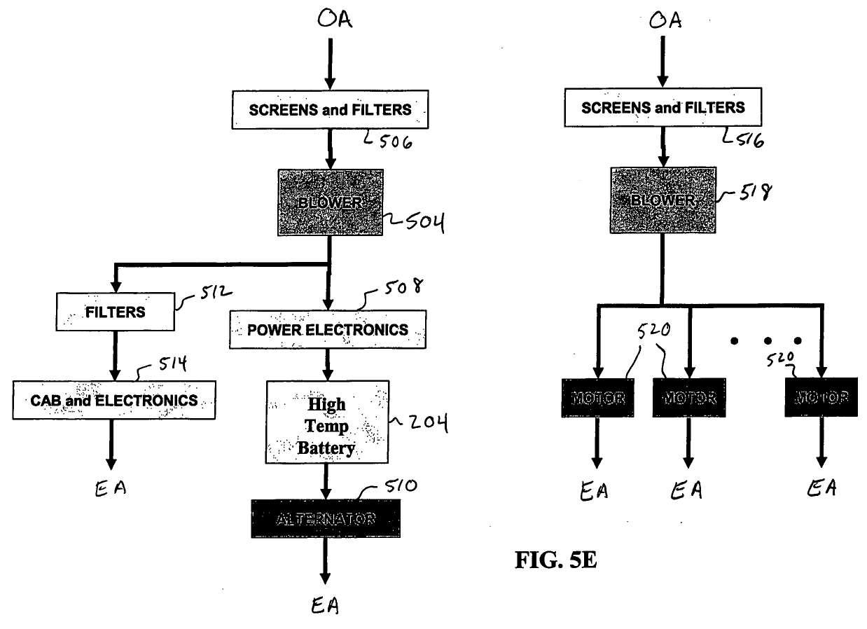

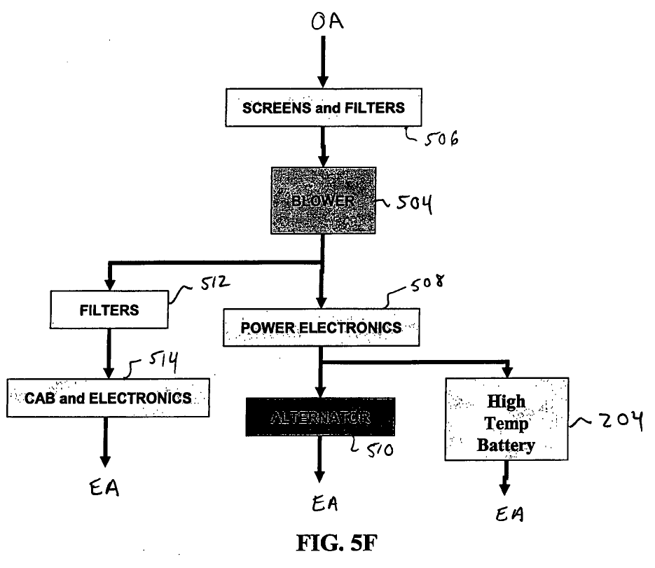

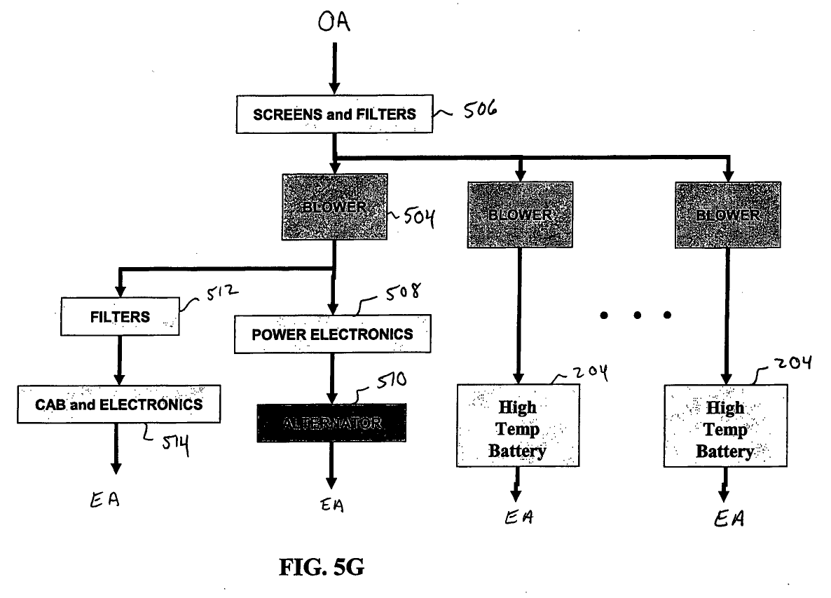

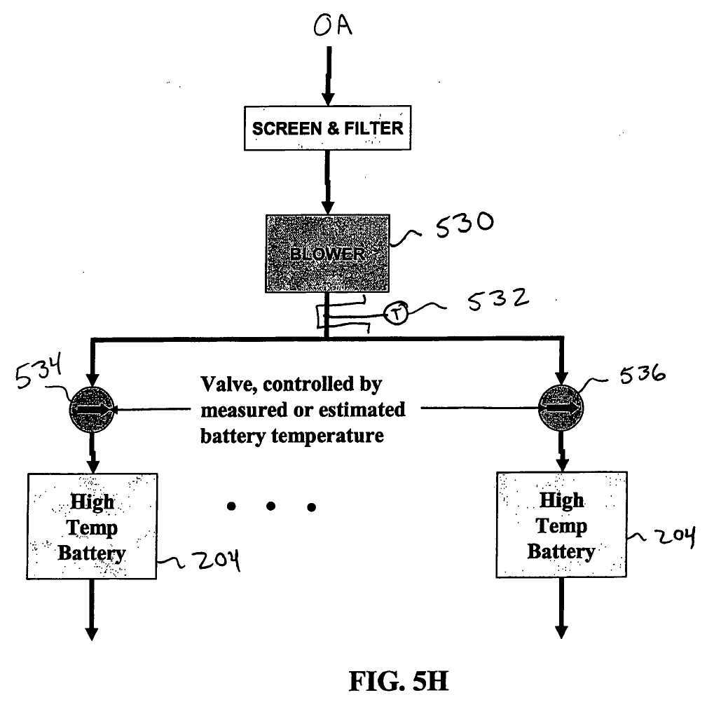

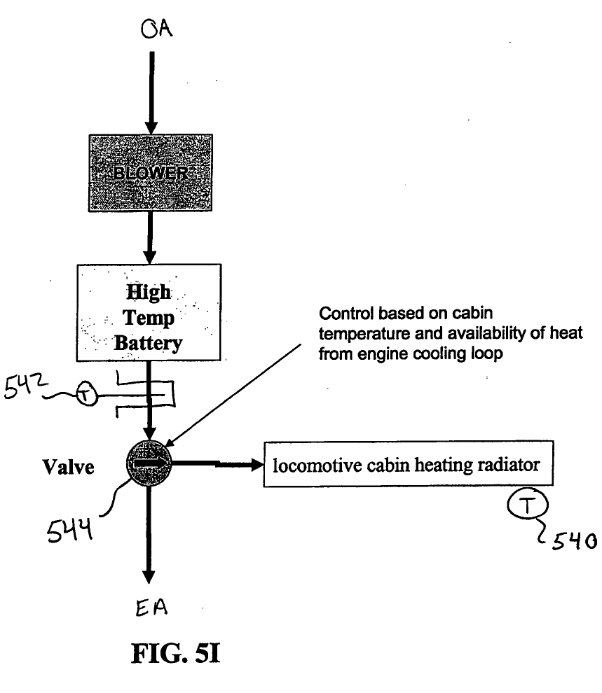

Referring to FIG. 5A, a conventional forced air cooling system 500 is illustrated. Such system generally include a plurality of air ducts 502 for directing outdoor, ambient or conditioned air to various components of the system 500. Blower 504 draws outdoor air OA through a plurality of screens and filters 506 and supplies the outdoor air OA to the various system components such as power electronics 508, alternator 510, etc., to cool these components. Additional filters 512 may be employed when the outdoor air OA is being supplied to an operator's cab or sensitive electronics 514. Furthermore, additional blowers 518 with corresponding screens and filters 516 will supply air to directly cool motors 520.

FIGS. 5B through 5I illustrate forced air cooling systems according to the principles of the present disclosure. In FIG. 5B, air is ducted from the exhaust of alternator 510 to the battery 204. In FIG. 5C, air is ducted directly from the discharge side of blower 504 to the battery 204, and in FIG. 5D, air discharged from the battery 204 is reclaimed and ducted back to cool the alternator 510. In FIG. 5E, the battery 204 is ducted between the power electronics 508 and the alternator 510, and in FIG. 5F, the battery 204 receives discharge air from the power electronics as in FIG. 5E but simply discharges the air after cooling the battery.

FIG. 5G illustrates a configuration where outdoor OA or ambient air is supplied directly to the batteries 204. This configuration is beneficial where maximum cooling is desired for example in warmer climates. Since the air reaching the batteries 204 is not preheated, the batteries will achieve a maximum temperature differential. A similar configuration is shown in FIG. 5H. Here, parallel battery boxes are fed from a single blower 530 and are independently controlled through the battery control system. The battery processor will determine the battery temperature as described above and acquire the blower discharge temperature via temperature sensor 532. Based on the battery temperature and blower discharge temperature, the battery processor will control dampers 534, 536 to provide the proper amount of air to cool the batteries.

In a further embodiment shown in FIG. 5I, the air heated by the battery may be used to heat the locomotive cabin. Battery processor 206 will acquire the temperature in the operator's cabin via space temperature sensor 540 and the discharge temperature of the battery via temperature sensor 542. The battery processor 206 will then determine if the battery discharge air can be used to heat the operator's cabin, and if so, will control damper 544 to divert discharge air to the operator's cabin through appropriate screens and filters. Alternatively, the discharge air will be directed to a heat exchanger coupled to a hydronic heating system so no direct air transfers will occur.

It is to be appreciated that FIGS. 5B through 5I are merely exemplary configurations of an air cooling systems used in conjunction with the battery control system to control the temperature of a battery and that many other configurations are available. It is also to be appreciated that the battery cooling system may be a stand-alone hydronic cooling system, a stand-alone air cooling system or a combination system of hydronic and air cooling.

The internal temperature of the battery will also be used to control the charging and discharging rates, in addition to the traditional state of charge (SOC). If the battery internal temperature is within a defined operating temperature range, e.g., internal temperature >T1, but <T2, the battery processor will allow discharge provided the battery terminal voltage and the State of Charge (SOC) is above predetermined limits. Similarly, if the internal temperature >T3, but <T4, the battery processor will allow recharge current, provided the battery terminal voltage and the State of Charge (SOC) is below predetermined limits. One example is for the battery processor to allow discharging if T1 and T2 are 270° C. and 350° C. respectively. In another example, recharge up to a predetermined high rate is allowed if T3 and T4 are 270° C. and 320° C. respectively, and the value of SOC is less than 70% of the battery's full charge. In yet another example, recharge at a predetermined low rate is allowed if T3 and T4 are 270° C. and 340° C., respectively and the SOC is less than 100%. In these examples, SOC is computed by a conventional manner, including integration of the battery current to determine the net Ampere Hours into and out of the battery.

The locomotives and off highway vehicles are used during a significant portion of the day/year. However during periods of shutdown, the internal battery temperature must stay above a predetermined limit. The battery control system 202 of the present disclosure will interact with various subsystems to ensure the battery stays warm, i.e., stays above the predetermined temperature limit. If during periods when the engine is shut down, and the battery temperature reaches a predetermined low temperature limits, the battery control system may sent a signal to restarted the engine until the battery is charged to a defined high state of charge so that the battery can keep itself warm. Since the locomotive is shutdown only for short periods of time normally, this reheating method of the battery is seldom expected. The battery control system may instruct the engine/alternator or the auxiliary source of power 203 to provide electric power to charge the battery, instruct the engine/alternator or the auxiliary source 203 to provide electric power to electric heating elements inside the battery, or, through a series of switches, could use the dc power terminals of the battery itself to power the electric heating elements. Furthermore, the engine hot exhaust gases may provide the heat for the battery.

After extensive shut down due to unscheduled events (e.g., extensive maintenance), the batteries can be heated using external means. For example, the batteries can also be kept hot by external dc/ac power with appropriate control via the battery processor. As another example, electric heater elements embedded in the battery may be employed or heater elements in the vehicle itself may be utilized, e.g., the dynamic braking grids. As an even further alternative, electric power may be applied to the battery terminals in a way to create a lot of internal losses in the battery, e.g., via high charging possibly followed by high discharging, which will heat the battery. It is also possible to prolong this period of time keeping the batteries warm with insulation/thermal management techniques/coolant temperature control as those described above.

If during long periods of locomotive and high-temperature battery inactivity, say at a siding, the battery temperature may fall close to its internal electrolyte freezing temperature, a the battery processor 206 will make a decision whether to use the battery internal energy to heat the battery or to allow the battery to freeze based on acquired variables, e.g., temperature sensors, or operator inputted information, e.g., time of shutdown If it is known that the locomotive will not operate earlier than a specified time such as 7 days, the battery processor will allow the battery to freeze. If the locomotive is expected to operate earlier than a specified time, the battery processor will enable, for example, the additional energy source 203, to electrically heat the batteries to keep them at operating temperature.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. An electric storage battery system carried on a hybrid energy off-highway vehicle including wheels for supporting and moving the vehicle, an electrical power generator, and traction motors for driving the wheels, with electrical power generated on the vehicle being stored at selected times in the electric storage battery system and discharged from the electric storage battery system for transmission to the traction motors to propel the vehicle, with the vehicle and battery system being exposed to a range of environmental conditions, the storage battery system comprising:
at least one battery for storing and releasing electrical power,
wherein the at least one battery generates an internal battery operating temperature that exceeds the highest environmental temperature of the vehicle.

2. The system as in claim 1, wherein the vehicle is a railroad locomotive.

3. The system as in claim 2, wherein the battery storage system is disposed in a locomotive tender coupled to the locomotive.

4. The system as in claim 1, wherein the internal battery operating temperature is about 270° C. to about 350° C.

5. The system as in claim 1, wherein the at least one battery is selected from the group consisting of a sodium nickel chloride battery or a sodium sulfur battery.

6. The system as in claim 1, further comprising:
a processor for determining at least one parameter associated with the at least one battery; and
a database for storing a plurality of thermal models for the at least one battery, wherein the processor selects at least one thermal model based on the at least one parameter associated with the battery.

7. The system as in claim 6, wherein the thermal model is indicative of an internal temperature of the battery.

8. The system as in claim 6, wherein the at least one parameter associated with the battery is potential battery internal case temperature, ambient temperature/pressure, time history of battery charge/discharge current, and time history of battery cooling fan(s) operation (coolant temperature/flow).

9. The system as in claim 7, wherein the battery comprises a plurality of battery cells.

10. The system as in claim 9, further comprising at least one temperature sensor for sensing a temperature of at least one of the plurality of battery cells.

11. The system as in claim 10, wherein the processor compares the temperature sensed from the at least one temperature sensor with the selected thermal model.

12. The system as in claim 1, wherein the vehicle further comprises a cooling system for dissipating heat generated from operating equipment on the vehicle, wherein the at least one battery is positioned to be part of the vehicle cooling system to dissipate heat from the at least one battery.

13. The system as in claim 12, wherein the cooling system delivers cooling air to the battery.

14. The system as in claim 12, wherein the cooling system delivers liquid coolant to the battery.

15. The system as in claim 1, wherein heat generated from the at least one battery delivers heating air to an operator cabin.

16. An electric storage battery system carried on a hybrid energy off-highway vehicle including wheels for supporting and moving the vehicle, an electrical power generator, and traction motors for driving the wheels, with electrical power generated on the vehicle being stored at selected times in the electric storage battery system and discharged from the electric storage battery system for transmission to the traction motors to propel the vehicle, with the vehicle and battery system being exposed to a range of environmental conditions, the electric storage battery system comprising:
at least one battery to store and release electrical power, with the battery operating at an internal battery temperature for effective storage and release of electric power, constituting an effective battery temperature, that is above that of the environmental temperatures of the vehicle and battery system, and with the battery cooling to a temperature lower than its effective internal operating temperature when the vehicle is out of service for extended period of time;
a monitor for sensing a parameter indicative of internal battery temperature; and
a controller for controlling heating of the battery back up to its effective battery temperature when the internal battery temperature falls below a predetermined level, so that the battery remains ready to operate effectively when the vehicle is returned to operation.

17. The electric storage battery system of claim 16, further comprising a source of electrical power connected to the battery, and wherein the controller directs the delivery of power to the battery to heat the battery to a desired internal temperature.

18. The electric storage battery system of claim 16, further comprising an external heater surrounding at least a portion of the battery, and wherein the controller controls the heater to heat the battery to a desired internal temperature.

19. The electric storage battery system of claim 16, wherein the monitored parameter of the battery is selected from the group comprising battery outer temperature, battery state of charge, air temperature history and battery charging and discharging history.

20. The electric storage battery system as in claim 16, wherein heat generated from the at least one battery delivers heating air to an operator cabin.
